(19) United States
(12) Patent Application Publication
(10) Pub. No.: US 2012/0215879 A1
(43) Pub. Date: Aug. 23, 2012

(54) Generating A Graphical Representation Of A User

(75) Inventor: Dhimiter Bozo, Brooklyn, NY (US)

(73) Assignee: Viacom International Inc., New York, NY (US)

(21) Appl. No.: 13/029,994

(22) Filed: Feb. 17, 2011

(51) Int. Cl. G06F 15/16

(52) U.S. Cl. 709/217

(57) ABSTRACT

Methods and apparatus are described for generating an online graphical representation of a user. For example, a method includes receiving, at a layering module, a request for an online graphical representation of a user, the request comprising indicia of a first asset and a second asset, the first asset and the second asset collectively providing an online graphical representation of the user; retrieving, with the layering module, a first file associated with the first asset and a second file associated with the second asset from an asset repository based on the indicia, the asset repository storing a plurality of files associated with assets including the first file and the second file; and compositing, with the layering module, the first and second file to form a first image being the online graphical representation of the user.

### FIELD OF THE INVENTION

The methods, computer readable media, and systems generally relate to generating an online graphical representation of a user. More particularly, the methods, computer readable media, and systems relate to compositing multiple assets to form an online graphical representation of a user.

### BACKGROUND

Websites and other online environments often use online graphical representations of users, sometime referred to as avatars, to identify users. The online graphical representation is typically a static image selected by the user from a set of predefined images. In such prior art systems, the user cannot customize certain aspects or characteristics of his online graphical representation efficiently and dynamically. For example, the user cannot change a single characteristic of his existing online graphical representation, such as clothing or hair color, without selecting an entirely new predefined image.

### SUMMARY

Methods and systems that allow the user to efficiently customize his online graphical representation are desirable. In one aspect, there is a computer-implemented method. The method can include receiving, at a layering module, a request for an online graphical representation of a user, the request comprising indicia of a first asset and a second asset, the first asset and the second asset collectively providing an online graphical representation of the user. The method can include retrieving, with the layering module, a first file associated with the first asset and a second file associated with the second asset from an asset repository based on the indicia, the asset repository storing a plurality of files associated with assets including the first file and the second file. The method can include compositing, with the layering module, the first and second file to form a first image being the online graphical representation of the user.

In another aspect, there is a computer program product, tangibly embodied in a non-transitory computer readable storage medium. The computer program product can include instructions being operable to cause one or more data processing apparatus to receive, at a layering module, a request for an online graphical representation of a user, the request comprising indicia of a first asset and a second asset, the first asset and the second asset collectively providing an online graphical representation of the user. The computer program product can include instructions being operable to cause one or more data processing apparatus to retrieve, with the layering module, a first file associated with the first asset and a second file associated with the second asset from an asset repository based on the indicia, the asset repository storing a plurality of files associated with assets including the first file and the second file. The computer program product can include instructions being operable to cause one or more data processing apparatus to composite, with the layering module, the first and second file to form a first image being the online graphical representation of the user.

In another aspect, there is a system. The system can include a layering module configured to receive a request for an online graphical representation of a user, the request comprising indicia of a first asset and a second asset, the first asset and the second asset collectively providing an online graphical representation of the user. The system can include an asset repository storing a plurality of files associated with assets including a first file associated with the first asset and a second file associated with a second asset, the layering module further configured to retrieve the first file and the second file from the asset repository based on the indicia, the layering module further configured to composite the first and second file to form a first image being the online graphical representation of the user.

Any of the above aspects can include one or more of the following features. The retrieving, with the layering module, the first file associated with the first asset and the second file associated with the second asset from the asset repository based on the indicia can include retrieving, with the layering module, a first identifier of the first file and a second identifier of the second file based on the indicia; retrieving the first file from the asset repository based on the first identifier; and retrieving the second file from the asset repository based on the second identifier.

The retrieving, with the layering module, the first identifier of the first file and the second identifier of the second file based on the indicia can include retrieving an ordered list comprising the first identifier and the second identifier, the ordered list indicating an order in which to composite the first file and the second file.

The computer-implemented can include storing, in a user profile stored on a profile service module, a first asset identifier associated with the first asset and a second asset identifier associated with the second asset; retrieving, with a web server, the first asset identifier and the second asset identifier from the profile service module; and serving, with the web server, a web page that includes the indicia, wherein the indicia comprises the first asset identifier and the second asset identifier.

The computer-implemented method can include storing, in the user profile, a third asset identifier associated with a third asset and a fourth asset identifier associated with a fourth asset, the third asset and the fourth asset collectively providing the online graphical representation of the user; retrieving, with the web server, the third asset identifier and the fourth asset identifier from the profile service module; serving, with the web server, a web page that includes a second indicia, wherein the second indicia comprises the third asset identifier and the fourth asset identifier; receiving, at the layering module, a second request for the online graphical representation of the user, the second request comprising the second indicia; retrieving, with the layering module, a third file and a fourth file from the asset repository based on the second indicia; and compositing, with the layering module, the third and fourth file to form a second image being the online graphical representation of the user.

The computer-implemented method can include resizing the first image based on the indicia. The assets can represent hair, a facial feature, a body, a shirt, pants, a dress, a skirt, or shoes.

The instructions being operable to cause one or more data processing apparatus to retrieve, with the layering module, the first file associated with the first asset and the second file associated with the second asset from the asset repository based on the indicia can include instructions to retrieve, with the layering module, a first identifier of the first file and a second identifier of the second file based on the indicia; retrieve the first file from the asset repository based on the first identifier; and retrieve the second file from the asset repository based on the second identifier.

The instructions being operable to cause one or more data processing apparatus to retrieve, with the layering module, the first identifier of the first file and the second identifier of the second file based on the indicia can include instructions to retrieve an ordered list comprising the first identifier and the second identifier, the ordered list indicating an order in which to composite the first file and the second file.

The computer program product can include instructions being operable to cause one or more data processing apparatus to store, in a user profile stored on a profile service module, a first asset identifier associated with the first asset and a second asset identifier associated with the second asset; retrieve, with a web server, the first asset identifier and the second asset identifier from the profile service module; and serve, with the web server, a web page that includes the indicia, wherein the indicia comprises the first asset identifier and the second asset identifier.

The computer program can include instructions being operable to cause one or more data processing apparatus to store, in the user profile, a third asset identifier associated with a third asset and a fourth asset identifier associated with a fourth asset, the third asset and the fourth asset collectively providing the online graphical representation of the user; retrieve, with the web server, the third asset identifier and the fourth asset identifier from the profile service module; serve, with the web server, a web page that includes a second indicia, wherein the second indicia comprises the third asset identifier and the fourth asset identifier; receive, at the layering module, a second request for the online graphical representation of the user, the second request comprising the second indicia; retrieve, with the layering module, a third file and a fourth file from the asset repository based on the second indicia; and composite, with the layering module, the third and fourth file to form a second image being the online graphical representation of the user.

The computer program product can include instructions being operable to cause one or more data processing apparatus to resize the first image based on the indicia.

The system can include a profile service module configured to store a first asset identifier associated with the first asset and a second asset identifier associated with the second asset; and a web server configured to retrieve the first asset identifier and the second asset identifier from the profile service module and to serve a web page that includes the indicia, wherein the indicia comprises the first asset identifier and the second asset identifier.

The system can include an image processing module configured to resize the first image.

In another aspect there is a computer-implemented method of generating a document defining a webpage that contains an online graphical representation of a user. The computer-implemented method can include retrieving, with a web server, a first asset identifier and a second asset identifier from a profile service module, the profile service module storing in a user profile the first asset identifier associated with a first asset and the second asset identifier associated with a second asset. The computer-implemented method can include generating a reference to the online graphical representation, the reference comprising the first asset identifier and the second asset identifier, the reference formatted to cause one or more data processing apparatus to composite a first image file associated with the first asset identifier and a second image file associated with the second asset identifier forming a first image being the online graphical representation of the user. The computer-implemented method can include adding the reference to the document. The reference can include a URL for the first image.

### BRIEF DESCRIPTION OF THE DRAWINGS

The advantages of the methods, computer readable media, and systems described above, together with further advantages, may be better understood by referring to the following description taken in conjunction with the accompanying drawings. The drawings are not necessarily to scale, emphasis instead being placed upon the principles of methods, computer readable media, and systems.

FIG. 1 depicts a webpage including a user's online graphical representation.

FIG. 2 depicts a webpage including multiple users' online graphical representations.

FIG. 3 depicts views of exemplary assets.

FIG. 4 depicts an exemplary system for generating an online graphical representation of a user.

FIG. 5 depicts an interface for modifying a user profile and displaying the online graphical representation of a user based on the selected user preferences.

FIG. 6 depicts the user profile that includes user preferences.

FIG. 7 depicts an exemplary XML file that provides the file names and paths for files associated with a set of asset identifiers.

FIG. 8 depicts a flow chart illustrating an exemplary method of generating an online graphical representation of a user.

### DETAILED DESCRIPTIONS

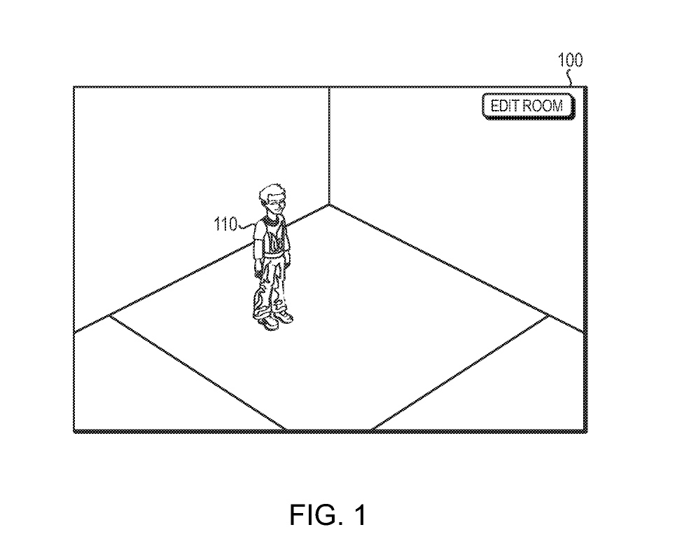

An online graphical representation, or avatar, of a user can be utilized to associate online activity with the user. The illustrative embodiments described herein can be utilized, for example, in conjunction with a website, a message board, and/or any other online interactive environments where users are associated with online graphical representations. The illustrative embodiments described herein can be used to provide an online graphical representation of a user that reflects the user's currently-selected preferences for her online graphical representation. For example, FIG. 1 depicts a webpage 100 including a user's online graphical representation 110. The webpage 100 shows the online graphical representation 110 in a virtual environment.

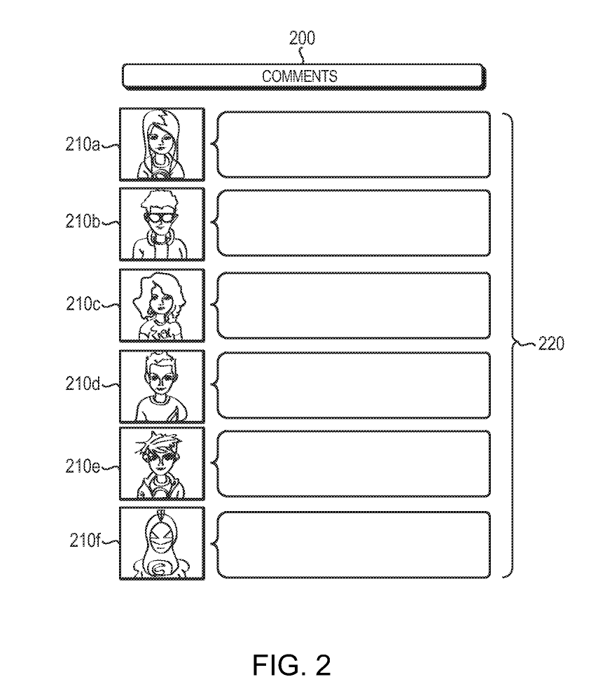

In some embodiments, The online graphical representation can be incorporated into a web page including a comment by the user to indicate the source of the comment. FIG. 2 depicts a webpage 200 including multiple users' online graphical representations 210a-210f. The webpage 200 includes the online graphical representations 210a-210f next to comments 220, thereby using the online graphical representations 210a-210f to identify the source of each of the comments 220. In other embodiments, the online graphical representation can be incorporated into web pages to indicate that the user has logged into a web environment. Other uses of the methods, computer readable media, and systems described herein, along with the online graphical representation generated, will be apparent to those skilled in the art.

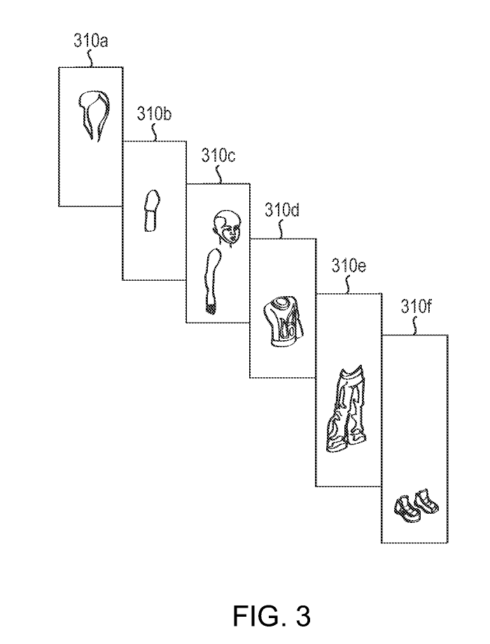

The methods, computer readable media, and systems described herein can be used to dynamically generate an online graphical representation of a user, such as those illustrated in FIG. 1 and FIG. 2. In some embodiments, a user's online graphical representation is a composite of one or more assets. FIG. 3 depicts views of exemplary assets 310a-310f. An asset can be an instance of a physical attribute, an article of clothing, or other graphic. For example, an asset can be a style of hair (e.g., asset 310a), such as long brown hair, short curly blonde hair, buzz cut, or any other hair style. An asset can be a particular depiction of physical features (e.g., assets 310b or 310c), such as a face, arm, leg, or body. An asset can be a particular article of clothing (e.g., assets 310d or 310e), such as a blue shirt, red dress, green pants, or any other article of clothing. An asset can be an accessory (e.g., asset 310f), such as shoes, glasses, a piece of jewelry, or a hat. It should be appreciated that the forgoing are merely examples of assets. Generally, an asset can be any graphic that can be a component of a user's online graphical representation.

The user's online graphical representation can be formed by compositing its constituent assets to form a single image. For example, compositing the assets 310a-310f, can form an online graphical representation or avatar. In this example, the avatar would have the hair illustrated by asset 310a and the face and arm illustrated by asset 310c. The avatar would be wearing the shirt illustrated by assets 310b and 310d, the pants illustrated by asset 310e, and the shoes illustrated by 310f. In this manner, a dynamic online graphical representation can be generated from separate assets.

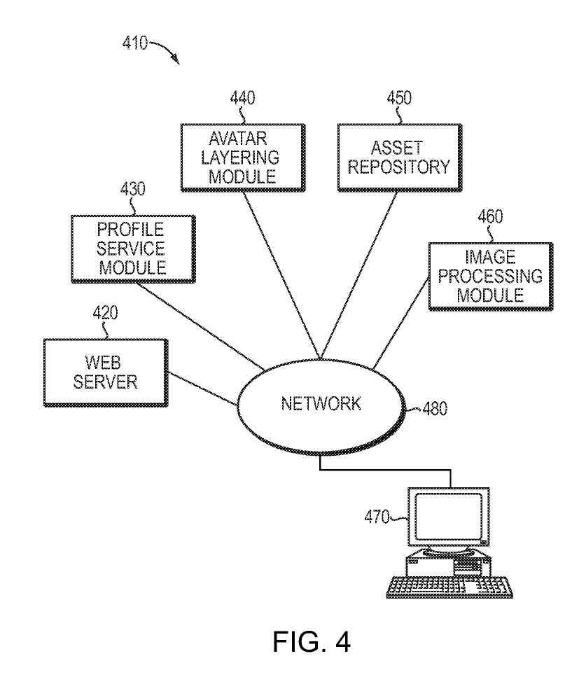

FIG. 4 depicts an exemplary system 410 for generating an online graphical representation of a user. System 410 can include a web server 420, a profile service module 430, an avatar layering module 440, an asset repository 450, an image processing module 460, and a user computing device 470. The components (e.g., the web server 420, the profile service module 430, the avatar layering module 440, the asset repository 450, the image processing module 460, and the user computing device 470) of the system 410 can be connected via network 480. Examples of networks include a bus, a local area network (LAN), a wide area network (WAN), the Internet, wired networks, wireless networks, a packet-based network, and/or a circuit-based network.

In some embodiments, network 480 can include one or more sub-networks (not shown). For example, the web server 420 can be connected to a private network along with the profile service module 430, the avatar layering module 440, the asset repository 450, and the image processing module 460. The web server 420 can be connected to a public network along with the user computing device 470. In such an embodiment, the user computing device 470 can communicate directly with the web server 420. It should be appreciated that other network topologies can be used in accordance with the methods, computer readable media, and systems disclosed herein.

The web server 420 can be any commercially-available web server software, such as, for example, the Apache web server provided by the Apache Software Foundation. The web server 420 can be any computer running appropriate web server software, as is well known in the art.

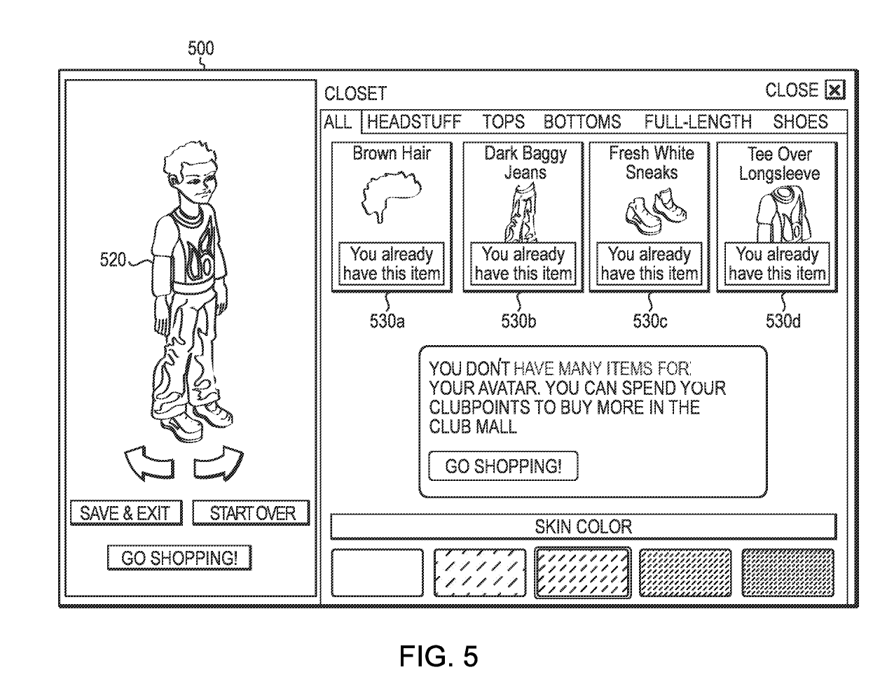

The profile service module 430 can store, manage, and update user profiles. User profiles can include various preferences of users, such as users' screen names and passwords. User preferences can include the assets selected by a user that will makeup the user's online graphical representation. FIG. 5 depicts an interface 500 for modifying a user profile and displaying the online graphical representation of a user 520 based on the selected user preferences. The interface 500 can be part of a webpage provided by web server 420. A user can alter his user profile through the interface 500 by interacting with the web server 420. For example, a user can use controls 530a-530d to select assets for his online graphical representation 520. The user can select hair via control 530a, pants via control 530b, shoes via control 530c, and a shirt via control 530d. Selections made using the controls 530a-530d are communicated to the profile service module 430. For example, a user can communicate the selections made in the interface 500 via an HTML POST command sent from the user computing device 470. Upon receiving the selections, the profile service module 430 can update the user profile accordingly. The online graphical representation 520 displayed in interface 500 is updated using the methods and systems described herein.

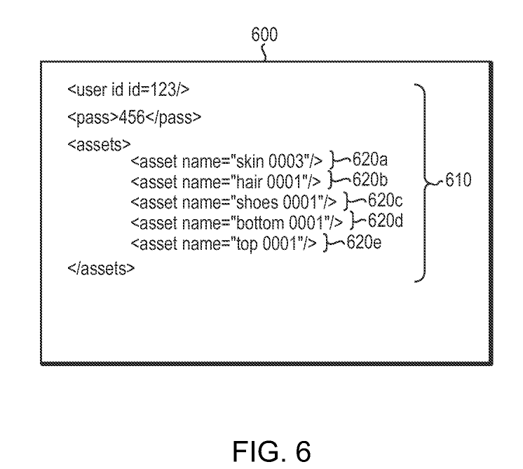

FIG. 6 depicts the user profile 600 that includes user preferences 610. The user profile 600 can be a computer file that includes user preferences 610 stored on the profile service module 430. For example, a portion of the user preferences 610 can be asset identifiers 620, which are associated with and identify the assets that a user selects to comprise his online graphical representation. As discussed in greater detail above, an asset can be, for example, an instance of a physical attribute, an article of clothing, or any other graphic that can be included in a user's online graphical representation.

Asset identifiers 620a-620e can be stored in the user profile 600 in any suitable format. For example, the user profile 600 can be a text file. The asset identifiers 620a-620e can be stored as XML, as illustrated. In some embodiments, asset identifiers can be a series of plain-text letters and/or numbers in the user profile, such as, for example, “hair 25, skin 3” (not shown). In other embodiments, the user profile can be a non-plain-text file, such as a binary or encrypted file (not shown). In the illustrated example, a particular face can be associated with the “skin” asset identifier 620a. A particular spiked hair style can be associated with the “hair” asset identifier 620b. A particular pair of white shoes can be associated with the “shoes” asset identifier 620c. A pair of jeans can be associated with the bottom” asset identifier 620d. A red shirt can be associate with the “top” asset identifier 620e. Generally, the asset identifiers 620 can provide a way to reference particular assets in the user profile 600 and in communications between the components of the system 410 (e.g., the web server 420, the profile service module 430, the avatar layering module 440, the asset repository 450, the image processing module 460, and the user computing device 470).

Returning to FIG. 4, the profile service module 430 can provide a requested user profile, or a portion thereof, to a requesting device. For example, the profile service module 430 can provide a requested user profile, or a portion thereof, including indicia of the assets that a user selects to comprise his online graphical representation (e.g., asset identifiers 620a-620e) to the web server 420, the avatar layering module 440, the asset repository 450, or the image processing module 460.

In some embodiments, the web server 420 requests the indicia of a user's online graphical representation from the profile service module 430. For example, the web server 420 can generate HTML code for a web page in response to a request by the user computing device 470. The web server 420 can include a reference (e.g., the src attribute of an HTML img tag) to a user's online graphical representation in the HTML code. In order to generate the reference to the user's online graphical representation, the web server 420 can request the asset identifiers (e.g., asset identifiers 620) for the user's online graphical representation from the profile service module 430. The profile service module 430 can return the asset identifiers to the web server 420 in various forms. For example, the profile service module 430 can return the asset identifiers in a string, such as “m_{—}0003_{—}0001_{—}0001_{—}0001_{—}0001.” In this example, the order of the asset identifiers in the string implicitly indicates whether each is for skin, hair, shoes, etc. In some embodiments, the web server 420 inserts the asset identifiers into the HTML code, for example, as <img src=“http://webserverdomainname/m_{—}0003_{—}0001_{—}0001_{—}0001_{—}0001.png”/>. In some embodiments the web server 420 can insert additional attributes into the HTML code, such as one or more dimensions for the online graphical representation (e.g., <img src=“http://webserverdomainname/m_{—}0003_{—}0001_{—}0001_{—}0001_{—}0001.png?width=72”/>).

The avatar layering module 440 can composite multiple image files into a single image file. Compositing refers to, for example, a process of combining elements from separate image files into a single image file, where the single image file depicts the elements in a single scene. For example, the avatar layering module 440 can composite an image file that depicts a body, an image file that depicts a shirt, and an image file that depicts pants into a single image file depicting the body wearing the shirt and pants. In some embodiments, the avatar layering module 440 uses one of several commercially-available image editing programs, such as Adobe Photoshop or GIMP, to perform compositing.

In some embodiments, the avatar layering module 440 can cache the image file that results from compositing one or more files. For example, if the avatar layering module receives a request to composite a group of image files that it already composited and the resulting image file is cached, the avatar layering module 440 can provide the resulting image file without the further processing described below.

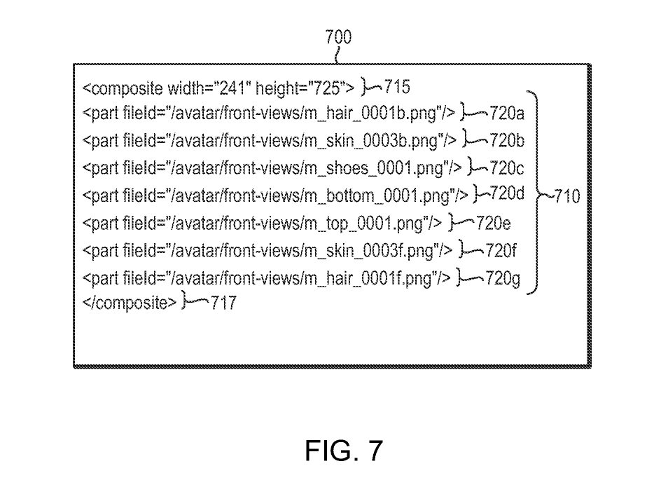

The avatar layering module 440 can request the file names and paths for the files associated with a set of asset identifiers, e.g., the set indicated by the string “m_{—}0003_{—}0001_{—}0001_{—}0001_{—}0001,” from the web server 420. In some embodiments, the web server 420 can provide the file names in an XML file or stream. FIG. 7 depicts an exemplary XML file 700 that provides the file names and paths for files associated with a set of asset identifiers. The XML file 700 can include composite elements, shown by opening tag 715 and closing tag 717. The composite element can have one or more attributes, such as, for example width and height. The composite element can have one or more child elements, such as, part elements 720a-720g. The part elements 720a-720g include a “fileId” attribute that indicates a filename and path of an image file associated with an asset identifier in the set of asset identifiers. In the XML file 700, the “part” elements are leaves (e.g., “part” elements do not have child elements).

The illustrated XML file 700 provides the file names and paths for files associated with asset identifiers 620 of FIG. 6. The part element 720a indicates an image file associated with the asset identifier “hair 001.” The part element 720b indicates an image file associated with the asset identifier “skin 003.” The part element 720c indicates an image file associated with the asset identifier “shoes 001.” The part element 720d indicates an image file associated with the asset identifier “bottom 001.” The part element 720e indicates an image file associated with the asset identifier “top 001.” The part element 720f indicates a second image file associated with the asset identifier “skin 003.” The part element 720g indicates a second image file associated with the asset identifier “hair 001.” The composited image formed from the image files indicated by the “part” elements 720a-720g can form a user's online graphical representation.

In some embodiments, the order of the part elements 720a-720g in the XML file 700 provides the order in which the avatar layering module 440 composites the image files associated with the part elements 720a-720g. For example, the XML file 700 instructs the avatar layering module 440 to composite the image file associated with the part element 720a first, the image file associated with the part element 720b second, the image file associated with the part element 720c third, the image file associated with the part element 720d fourth, etc. Accordingly, the avatar layering module 440 uses the image file associated with the part element 720a to form a first layer of the composite image. The avatar layering module 440 uses the image file associated with the part element 720b to form a second layer of the composite image, where the second layer is placed on top of the first layer and can occlude portions of the first layer in the composite image. The avatar layering module 440 uses the image file associated with the part element 720c to form a third layer of the composite image, where the third layer is placed on top of the first and second layers and can occlude portions of the first and second layers in the composite image. The avatar layering module 440 continues in a similar manner with the image files indicated by the part elements 720d-720g.

The sequence in which one asset occludes another in the composite online image can be controlled by the order of the part elements. For example, in an online graphical representation (not shown) including a tie and a dress shirt, the tie should appear over the dress shirt in a front view. An XML file that includes the part elements for such an online graphical representation lists the part element for the dress shirt before the part element for the tie to instruct the avatar layering module 440 to place the tie over the dress shirt in the composited image. Alternatively, in a rear view of the composite image for the same user, the dress shirt would cover the tie, and so the part element for the tie would precede the part element associated with the shirt. Compositing can be performed using the layers feature of, for example, Adobe Photoshop or GIMP.

The asset repository 450 can store files (not shown) associated with assets and asset identifiers. The files associated with the assets can be computer image files that depict the assets. For example, an asset that is a red shirt can be associated with one or more computer image files depicting that red shirt. In some applications, more than one file can be associated with an asset. For example, the files associated with the asset can depict the asset from different views or angles. In some embodiments, the files can be in any format used to represent an image. For example, the files can be encoded in the JPEG, GIF, TIFF, BMP, or any other suitable computer image file format. In other embodiments, the files can be in a format that can be converted to an image, such as SWF or MPEG.

The asset repository 450 can also provide one or more image files associated with an asset and/or asset identifier in response to a request from, for example, the avatar layering module 440. In some embodiments, the request can identify the image file by its filename and path (e.g., “/avatar/front-views/m_bottom_{—}0001.png”). In some embodiments another identifier of the file can be used. Upon receiving the request, the asset repository 450 searches its contents for the file and returns the file to the requester.

In some embodiments, asset repository 450 includes a database. For example, the database can maintain a relation between the asset identifier and a file or files. In other embodiments, asset repository 450 stores files in a file system, such as ext3, ReiserFS, or NTFS and includes the asset identifier in filenames or metadata.

Asset repository 450 can use a variety of protocols to receive requests for and/or provide the files associated with assets and/or asset identifiers. In some embodiments, the asset repository 450 can communicate using the FTP protocol. The asset repository 450 can communicate using the HTTP protocol. The asset repository 450 can operate as network attached storage communicating with the NFS protocol. It should be appreciated that asset repository can communicate with any protocol suitable for file transfer.

Returning to FIG. 4, the image processing module 460 can manipulate image files. For example, image processing module 460 can change the resolution of or resize images files. The mage processing module 460 can utilize any commercially-available photo editing software.

In some embodiments, the web server 420, the profile service module 430, the avatar layer module 440, the asset repository 450, and the image processing module 460 can be stand-alone computing devices, such as servers running appropriate software. In some embodiments, the web server 420, the profile service module 430, the avatar layering module 440, the asset repository 450, and the image processing module 460 can be software modules running on a single computing device. The web server 420, the profile service module 430, the avatar layer module 440, the asset repository 450, and the image processing module 460 can be implemented as any combination of stand-alone computing devices and/or software modules.

User computing device 470 can be any computing device capable of running, for example, a web browser. The user computing device 470 can be, for example, a laptop, desktop, server, smartphone, or PDA.

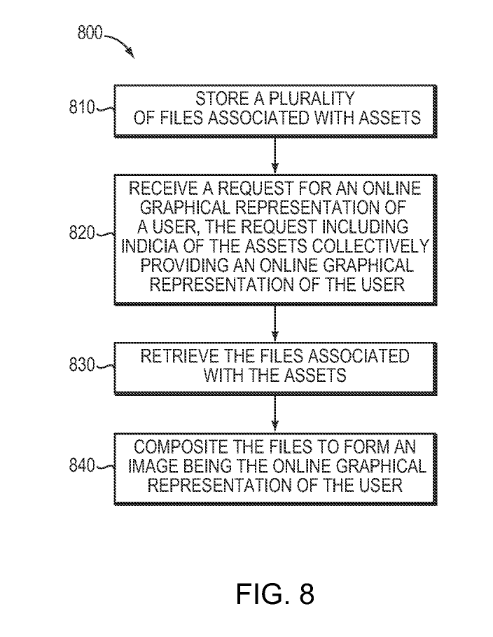

FIG. 8 depicts a flow chart 800 illustrating an exemplary method of generating an online graphical representation of a user. At step 810, a plurality of files associated with assets are stored. As previously discussed, an asset can be an instance of a physical attribute, clothing, or other graphic. Files associated with assets can be computer image files that depict the assets. In some embodiments, the files are stored on the asset repository 450 of FIG. 4.

At step 820, a request for an online graphical representation of a user is received. The request can include indicia of the assets collectively providing an online graphical representation of the user. In some embodiments, the indicia can be a string identifying asset identifiers (e.g., “m_{—}0003_{—}0001_{—}0001_{—}0001_{—}0001”). In some embodiments, the user computing device 470 can send an HTTP GET command to request an image file, where the image file name includes the indicia (e.g., “m_{—}0003_{—}0001_{—}0001_{—}0001_{—}0001.png”). In some embodiments, the user computing device can send the GET request to the web server 420 or the avatar layering module 440.

At step 830, files associated with the assets indicated by the indicia are retrieved. For example, the avatar layering module 440 can provide the indicia received in step 820 (e.g., “m_{—}0003_{—}0001_{—}0001_{—}0001_{—}0001”) to the web server 420. As described above, the web server 420 can provide the file names and paths for files associated with the asset identifiers in the indicia. The avatar layering module 440 can retrieve the files associated with the assets indicated by the indicia using the file names and paths provided.

At step 840, the files retrieved in step 830 are composited to form an image that is the online graphical representation of the user. In some embodiments, the avatar layering module 440 composites the files retrieved.

The above-described techniques and systems can be implemented in digital electronic circuitry, or in computer hardware, firmware, software, or in combinations of them. The implementation can be as a computer program product, e.g., a computer program tangibly embodied in an information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

While the invention has been particularly shown and described with reference to specific illustrative embodiments, it should be understood that various changes in form and detail may be made without departing from the spirit and scope of the invention.

1. A computer-implemented method comprising:
receiving, at a layering module, a request for an online graphical representation of a user, the request comprising indicia of a first asset and a second asset, the first asset and the second asset collectively providing an online graphical representation of the user;
retrieving, with the layering module, a first file associated with the first asset and a second file associated with the second asset from an asset repository based on the indicia, the asset repository storing a plurality of files associated with assets including the first file and the second file; and
compositing, with the layering module, the first and second file to form a first image being the online graphical representation of the user.

2. The computer-implemented method of claim 1, wherein retrieving, with the layering module, the first file associated with the first asset and the second file associated with the second asset from the asset repository based on the indicia comprises:
retrieving, with the layering module, a first identifier of the first file and a second identifier of the second file based on the indicia;
retrieving the first file from the asset repository based on the first identifier;
retrieving the second file from the asset repository based on the second identifier.

3. The computer-implemented method of claim 2, wherein retrieving, with the layering module, the first identifier of the first file and the second identifier of the second file based on the indicia comprises:
retrieving an ordered list comprising the first identifier and the second identifier, the ordered list indicating an order in which to composite the first file and the second file.

4. The computer-implemented method of claim 1, further comprising:
storing, in a user profile stored on a profile service module, a first asset identifier associated with the first asset and a second asset identifier associated with the second asset;
retrieving, with a web server, the first asset identifier and the second asset identifier from the profile service module; and
serving, with the web server, a web page that includes the indicia, wherein the indicia comprises the first asset identifier and the second asset identifier.

5. The computer-implemented method of claim 4, further comprising:
storing, in the user profile, a third asset identifier associated with a third asset and a fourth asset identifier associated with a fourth asset, the third asset and the fourth asset collectively providing the online graphical representation of the user;
retrieving, with the web server, the third asset identifier and the fourth asset identifier from the profile service module;
serving, with the web server, a web page that includes a second indicia, wherein the second indicia comprises the third asset identifier and the fourth asset identifier;
receiving, at the layering module, a second request for the online graphical representation of the user, the second request comprising the second indicia;
retrieving, with the layering module, a third file and a fourth file from the asset repository based on the second indicia; and
compositing, with the layering module, the third and fourth file to form a second image being the online graphical representation of the user.

6. The computer-implemented method of claim 1, further comprising:
resizing the first image based on the indicia.

7. The computer-implemented method of claim 1, wherein each of the assets represents hair, a facial feature, a body, a shirt, pants, a dress, a skirt, or shoes.

8. A computer program product, tangibly embodied in a non-transitory computer readable storage medium, including instructions being operable to cause one or more data processing apparatus to:
receive, at a layering module, a request for an online graphical representation of a user, the request comprising indicia of a first asset and a second asset, the first asset and the second asset collectively providing an online graphical representation of the user;
retrieve, with the layering module, a first file associated with the first asset and a second file associated with the second asset from an asset repository based on the indicia, the asset repository storing a plurality of files associated with assets including the first file and the second file; and
composite, with the layering module, the first and second file to form a first image being the online graphical representation of the user.

9. The computer program product of claim 8, wherein the instructions being operable to cause one or more data processing apparatus to retrieve, with the layering module, the first file associated with the first asset and the second file associated with the second asset from the asset repository based on the indicia comprise instructions to:
retrieve, with the layering module, a first identifier of the first file and a second identifier of the second file based on the indicia;
retrieve the first file from the asset repository based on the first identifier;
retrieve the second file from the asset repository based on the second identifier.

10. The computer program product of claim 9, wherein the instructions being operable to cause one or more data processing apparatus to retrieve, with the layering module, the first identifier of the first file and the second identifier of the second file based on the indicia comprise instructions to:
retrieve an ordered list comprising the first identifier and the second identifier, the ordered list indicating an order in which to composite the first file and the second file.

11. The computer program product of claim 8, further comprising instructions being operable to cause one or more data processing apparatus to:
store, in a user profile stored on a profile service module, a first asset identifier associated with the first asset and a second asset identifier associated with the second asset;
retrieve, with a web server, the first asset identifier and the second asset identifier from the profile service module; and
serve, with the web server, a web page that includes the indicia, wherein the indicia comprises the first asset identifier and the second asset identifier.

12. The computer program product of claim 11, further comprising instructions being operable to cause one or more data processing apparatus to:
store, in the user profile, a third asset identifier associated with a third asset and a fourth asset identifier associated with a fourth asset, the third asset and the fourth asset collectively providing the online graphical representation of the user;
retrieve, with the web server, the third asset identifier and the fourth asset identifier from the profile service module;
serve, with the web server, a web page that includes a second indicia, wherein the second indicia comprises the third asset identifier and the fourth asset identifier;
receive, at the layering module, a second request for the online graphical representation of the user, the second request comprising the second indicia;
retrieve, with the layering module, a third file and a fourth file from the asset repository based on the second indicia; and
composite, with the layering module, the third and fourth file to form a second image being the online graphical representation of the user.

13. The computer program product of claim 8, further comprising instructions being operable to cause one or more data processing apparatus to:
resize the first image based on the indicia.

14. The computer program product of claim 8, wherein each of the assets represents hair, a facial feature, a body, a shirt, pants, a dress, a skirt, or shoes.

15. A system comprising:
a layering module configured to receive a request for an online graphical representation of a user, the request comprising indicia of a first asset and a second asset, the first asset and the second asset collectively providing an online graphical representation of the user;
an asset repository storing a plurality of files associated with assets including a first file associated with the first asset and a second file associated with a second asset, the layering module further configured to retrieve the first file and the second file from the asset repository based on the indicia, the layering module further configured to composite the first and second file to form a first image being the online graphical representation of the user.

16. The system of claim 15, further comprising:
a profile service module configured to store a first asset identifier associated with the first asset and a second asset identifier associated with the second asset;
a web server configured to retrieve the first asset identifier and the second asset identifier from the profile service module and to serve a web page that includes the indicia, wherein the indicia comprises the first asset identifier and the second asset identifier.

17. The system of claim 15, further comprising:
an image processing module configured to resize the first image.

18. The system of claim 15, wherein each of the assets represents hair, a facial feature, a body, a shirt, pants, a dress, a skirt, or shoes.

19. A computer-implemented method of generating a document defining a webpage that contains an online graphical representation of a user comprising:
retrieving, with a web server, a first asset identifier and a second asset identifier from a profile service module, the profile service module storing in a user profile the first asset identifier associated with a first asset and the second asset identifier associated with a second asset;
generating a reference to the online graphical representation, the reference comprising the first asset identifier and the second asset identifier, the reference formatted to cause one or more data processing apparatus to composite a first image file associated with the first asset identifier and a second image file associated with the second asset identifier forming a first image being the online graphical representation of the user; and
adding the reference to the document.

20. The computer-implemented method of claim 19, wherein the reference comprises a URL for the first image.
